(19) United States
(12) Patent Application Publication
(10) Pub. No.: US 2018/0317406 A1
(43) Pub. Date: Nov. 8, 2018

(54) DRIP IRRIGATION EMITTER, AN IRRIGATION PIPE WITH A PLURALITY OF SUCH EMITTERS, METHOD FOR PRODUCING SUCH EMITTERS AND METHOD OF IRRIGATION USING THEM

(71) Applicant: TERRACUITY TECHNOLOGIES LTD., Tel Aviv (IL)

(72) Inventors: Gill Rafael Tsouri, Omer (IL); Nimrod Ari, Kokhav Yair (IL)

(21) Appl. No.: 15/773,079

(22) PCT Filed: Jun. 16, 2016
(86) PCT No.: PCT/IL2016/050633

§ 371 Date: May 2, 2018

Related U.S. Application Data
(60) Provisional application No. 62/250,969, filed on Nov. 4, 2015.
(60) Provisional application No. 62/289,971, filed on Feb. 2, 2016.

(51) Int. Cl. A01G 25/02

(52) U.S. Cl. CPC A01G 25/023; A01G 25/02

(57) ABSTRACT

A drip irrigation emitter comprises an emitter inlet, an emitter outlet, an irrigation fluid path extending therebetween including a pressure-reducing mechanism configured to convert fluid flow entering the emitter inlet under pressure, into a drip flow from the outlet. The emitter further comprises a fluid-accumulation chamber having at least one chamber orifice configured for being brought into fluid communication with an exterior of the emitter for receiving therefrom an accumulatable fluid and further configured to allow introduction of the accumulatable fluid into the chamber via the orifice. This allows the chamber to change its state between a first state, in which the amount of the accumulatable fluid in the chamber is minimal and at least one second state, in which amount of the accumulatable fluid in the chamber reaches a predetermined value higher than the minimal value, the arrangement being such that when the chamber is in the second state, drip flow rate through the emitter outlet changes in accordance with the predetermined value.

### TECHNOLOGICAL FIELD

The presently disclosed subject matter is directed to the field of drip irrigation and, particularly, to the control of amount of fluid dispensed by a drip irrigation emitter when mounted in or on a drip irrigation pipe.

### BACKGROUND

Drip irrigation emitters are commonly comprised of an inlet, an outlet and a pressure-reducing mechanism therebetween configured to convert fluid flow entering the emitter inlet under pressure, into a drip flow from the emitter outlet. The emitter is connected to an irrigation pipe to draw fluid through its inlet and dispense it to the outside environment by dripping from its outlet. U.S. Pat. No. 3,753,527; U.S. Pat. No. 4,317,539; U.S. Pat. No. 3,954,223 are representative examples of existing emitters following the aforementioned description.

Typically, multiple drip irrigation emitters are connected externally or internally to an irrigation pipe and multiple such irrigation pipes are spaced apart on the ground to irrigate areas.

### GENERAL DESCRIPTION

According to one aspect of the presently disclosed subject matter, there is provided a drip irrigation emitter comprising:
an emitter inlet, an emitter outlet, an irrigation fluid path extending therebetween including a pressure-reducing mechanism configured to convert fluid flow entering the emitter inlet under pressure, into a drip flow from the outlet, and
a fluid-accumulation chamber having at least one chamber orifice configured for being brought into fluid communication with an exterior of the emitter for receiving therefrom an accumulatable fluid and further configured to allow introduction of the accumulatable fluid into the chamber via the orifice, to cause the chamber to change its state between a first state, in which the amount of said accumulatable fluid in the chamber is minimal and at least one second state, in which amount of the accumulatable fluid in the chamber reaches a predetermined value higher than the minimal value, the arrangement being such that when the chamber is in the second state, drip flow rate through the emitter outlet changes in accordance with said predetermined value.

In the first state of the chamber, it can be free of said accumulatable fluid.

In the second state of the chamber, the predetermined amount of the accumulatable fluid can be such that fluid communication between the pressure-reducing mechanism and the emitter outlet is completely prevented, i.e. the flow rate through the outlet equals zero. This maximal value of the amount of the accumulatable fluid in the chamber can be selected so as to ensure that it is reached only after a predetermined amount of irrigation fluid has been dispensed from the emitter outlet.

The predetermined amount of the accumulatable fluid can be selected so as to ensure that this amount is reached only when a predetermined level of moisture has been reached at the exterior of the emitter outlet.

The drip irrigation emitter can comprise a housing having a housing front surface and a housing rear surface, the housing front surface being formed with said emitter inlet and the housing rear surface being formed with a housing outlet. In this case, the housing comprises a first part of said irrigation fluid path extending between said emitter inlet and the housing outlet, with said pressure-reducing mechanism therebetween. The housing can further comprise a cover formed with said emitter outlet, the cover being so assembled with the housing as to form a space between the housing rear surface and the emitter outlet, said space constituting a second part of said irrigation fluid path. This space can be configured to accommodate said chamber at least in the second state.

The orifice of the chamber can be in fluid communication with the emitter inlet via an accumulatable fluid path, so as to allow fluid entering the emitter via said emitter inlet to simultaneously flow along the first part of the irrigation fluid path and along the accumulatable fluid path, which can comprise a pressure-reducing mechanism partially or completely different from that of the irrigation fluid path.

The chamber can have an interior filled with a moisture-sensitive material, in which case its orifice can be in fluid communication with an exterior of the emitter at least at one location in the housing other than the emitter inlet such as to prevent fluid communication of the orifice with the emitter inlet.

The drip irrigation emitter can be of an on-line type, i.e. configured for being mounted onto an exterior surface of an irrigation pipe so as to provide fluid communication of the emitter inlet with an interior of the irrigation pipe, or of an in-line type, i.e. configured for being integrally attached to an interior surface of an irrigation pipe so as to provide fluid communication of the emitter inlet with an interior of the irrigation pipe and of the emitter outlet with an exterior of the pipe.

In accordance with a further aspect of the presently disclosed subject matter, there is provided an irrigation pipe comprising a plurality of drip irrigation emitters of the kind described above, disposed at different distances from a location, at which the pipe is configured to receive therein pressurized irrigation fluid. The irrigation type can be operable at least at one fluid pressure at said location so that, once said chamber is in its second state in at least one of the drip emitters, at least some of the remaining drip emitters will experience an increased pressure of fluid at their inlets.

In accordance with a still further aspect of the presently disclosed subject matter, there is provided an irrigation pipe comprising a plurality of drip irrigation emitters disposed at different distances from a location, at which the pipe is configured to receive therein pressurized irrigation fluid, each emitter comprising:
an emitter inlet, an emitter outlet, an irrigation fluid path extending therebetween including a pressure-reducing mechanism configured to convert fluid flow entering the emitter inlet under pressure, into a drip flow from the outlet, and
a mechanism configured to change a state of the fluid irrigation path between a first, operational state allowing said drip flow from the outlet, and a second state in which fluid communication is prevented between the pressure-reducing mechanism and the emitter outlet, so that at least at one fluid pressure at said location, at least once the state of the irrigation fluid path reaches its second state in at least one of the drip emitters, at least some of the remaining drip emitters will experience an increased pressure of fluid at their inlets.

In accordance with a still further aspect of the presently disclosed subject matter, there is provided a method of producing a drip irrigation emitter with a drip flow rate dependent on the amount of fluid that has been dispensed therefrom or on a moisture at the exterior of the emitter, the method comprising providing the emitter with a fluid-accumulation chamber having at least one chamber orifice configured for being brought into fluid communication with an exterior of the emitter for receiving therefrom an accumulatable fluid and further configured to allow introduction of the accumulatable fluid into the chamber via the orifice, to cause the chamber to change its state between a first state, in which the amount of said accumulatable fluid in the chamber is minimal and at least one second state other than the first state, in which amount of the accumulatable fluid in the chamber reaches a predetermined value higher than the minimal value, the arrangement being such that when the chamber is in the second state, drip flow rate through the emitter outlet changes in accordance with said predetermined value.

According to a still further aspect of the presently disclosed subject matter, there is provided a method of drip irrigation by means of a pipe comprising a plurality of drip irrigation emitters disposed at different distances from a location, at which the pipe is configured to receive therein pressurized irrigation fluid, said method comprising using, as at least a part of said emitters, drip irrigation with drip flow rate from their outlets which varies between a maximal rate in a first, operational state of the emitter and a reduced rate in at least one second state of the emitter, so that at least at one fluid pressure at said location, at least when at least one of the drip emitters is in its second state, at least some of the remaining drip emitters will experience an increased pressure of fluid at their inlets.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of a drip irrigation emitter with its fluid-accumulating chamber in its first state, according to an example of the presently disclosed subject matter.

FIG. 2 is a schematic illustration of the drip irrigation emitter of FIG. 1 with fluid-accumulating chamber in its second state.

FIG. 3 is an illustrative example of a drip irrigation system making use of any drip irrigation emitter of the presently disclosed subject matter.

FIG. 4 is a schematic illustration of an on-line drip irrigation emitter, in accordance with one embodiment of the presently disclosed subject matter.

FIG. 5 is a first exploded view of the emitter of FIG. 4.

FIG. 6 is a second exploded view of the emitter of FIG. 4.

FIG. 7 is a side view of a housing of the emitter of FIG. 4 with fluid-accumulating chamber in its second state.

FIG. 8 illustrates an interior of housing of the emitter of FIG. 4 between front surface of housing and rear surface of housing.

FIG. 9 shows a housing of an on-line drip irrigation emitter, in accordance with another embodiment of the presently disclosed subject matter.

FIG. 10 illustrates interior of the emitter of FIG. 9 between front surface of housing and rear surface of housing.

FIG. 11 is an exploded view of an integral drip irrigation emitter, in accordance with yet another embodiment of the presently disclosed subject matter.

FIG. 12 is a side view of a housing of the emitter of FIG. 11 with its fluid-accumulating chamber in its second state.

FIG. 13 is an exploded view an integral drip irrigation emitter, in accordance with a yet another embodiment of the presently disclosed subject matter.

FIG. 14 is a side view of a housing of the emitter of FIG. 13 with its fluid-accumulating chamber in its second state.

### DETAILED DESCRIPTION OF EMBODIMENTS

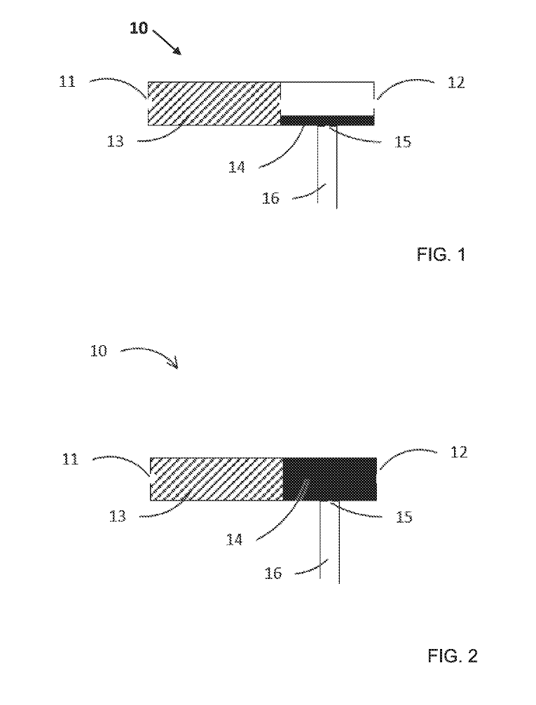

FIG. 1 schematically shows one example of a drip irrigation emitter 10 of the presently disclosed subject matter. The drip irrigation emitter 10 comprises an emitter inlet 11, an emitter outlet 12 and an irrigation fluid path extending therebetween including a pressure-reducing mechanism 13. The drip irrigation emitter 10 further comprises a sealed fluid-accumulation chamber 14 having at least one chamber orifice 15 in fluid communication with emitter's exterior via accumulatable fluid path 16. The sealed fluid-accumulation chamber 14 is presented in its first state of being free of accumulatable fluid. FIG. 2 shows drip irrigation emitter 10 with the fluid-accumulation chamber 14 in its second state of containing a predetermined amount of accumulatable fluid.

When pressurized fluid enters the emitter inlet 11, the pressure-reducing mechanism 13 converts it into a drip flow from the emitter outlet 12. When the accumulatable fluid path 16 introduces accumulatable fluid to the sealed fluid-accumulation chamber 14 via the chamber orifice 15, the sealed fluid-accumulation chamber transitions from its first state of being free of accumulatable fluid and allowing drip flow through outlet 12 to its second state of containing a predetermined amount of accumulatable fluid and preventing drip flow through outlet 12.

The fluid-accumulation chamber 14 is configured to discharge its content to the exterior of drip irrigation emitter 10 from the chamber orifice 15 via accumulatable fluid path 16 thereby reverting back to its first state of being free of accumulatable fluid.

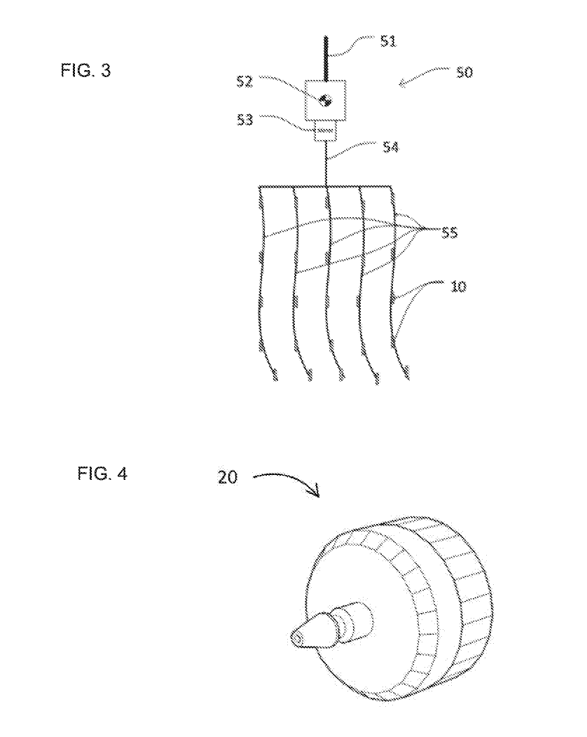

FIG. 3 shows a drip irrigation system 50 comprised of a main fluid line 51, an optional flow controller 52, an optional pressure and/or flow meter 53, a secondary fluid line 54 and a network of pipes 55 each with a plurality of drip irrigation emitters 10 of a kind similar to emitter 10 described above, disposed at different distances from the location where pipes 55 receive pressurized irrigation fluid from secondary fluid line 54. Pipes 55 may cover great distances and/or varying topography.

When at least some of the fluid-accumulation chambers 14 of emitters 10 are in their first state and the irrigation system 50 introduces pressurized fluid to pipes 55, the emitters 10 along pipes 55 experience varying fluid pressure at their inlets 11 depending on on their distance from the secondary fluid line 54 and their topographical position. Over time, the fluid-accumulation chambers 14 of some of the emitters 10 along the pipes 55 transition to their second state, thereby increasing the pressure of fluid at the inlets 11 of the emitters along pipes 55 whose fluid-accumulation chamber 14 is still in its first state. Eventually, all fluid-accumulation chambers 14 of emitters 10 along pipes 55 transition to their second state. At this time, the system 50 stops introducing pressurized fluid to secondary fluid line 54. The fluid-accumulation chambers 14 of emitters 10 along pipes 55 revert to their first state according to their discharge configuration.

The operation of irrigation system 50 described above constitutes one example of an irrigation cycle and may be repeated depending on irrigation needs.

FIG. 4 shows one embodiment of the presently disclosed subject matter in the form of an on-line drip irrigation emitter 20 designed so that its fluid-accumulation chamber transitions to its second state only when a predetermined amount of irrigation fluid has been dispensed from the emitter's outlet.

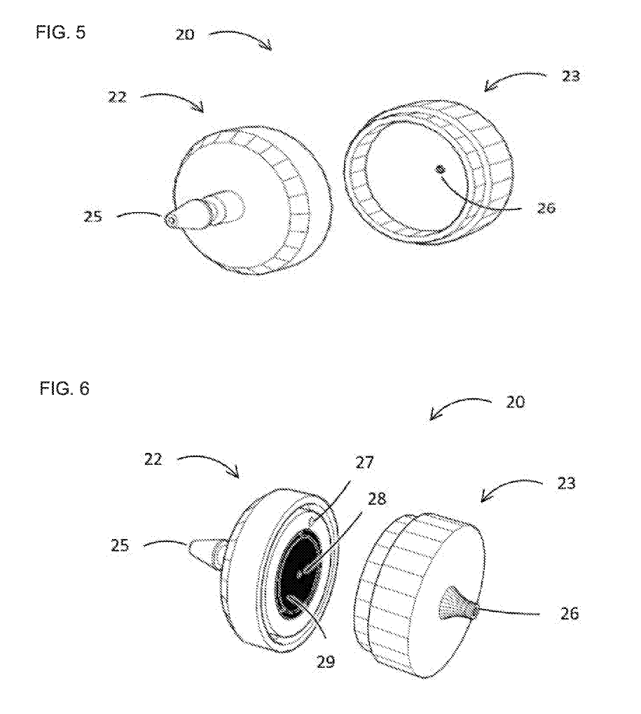

FIG. 5 shows a first exploded view of drip irrigation emitter 20 comprising a housing 22 and a cover 23. Housing 22 has a housing front surface formed with inlet nozzle 25. Cover 23 has an interior and an emitter outlet 26.

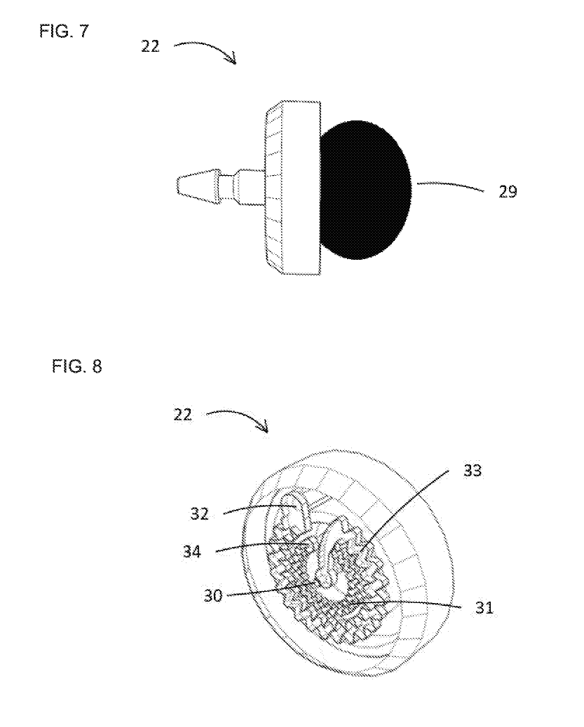

FIG. 6 shows a second exploded view of drip irrigation emitter 20 with inlet nozzle 26 pointing away from viewer. Housing 22 comprises a housing outlet 27 in its rear surface and a chamber orifice 28 sealed by an expandable material implementing a fluid-accumulation chamber 29 and presented in its first state of being free of fluid. FIG. 7 shows a side view of housing 22 when the fluid-accumulation chamber 29 is in its second state of containing a predetermined amount of accumulatable fluid.

When housing 22 and cover 23 are assembled, the interior of cover 23 forms a space between the housing rear surface and the emitter outlet 26.

FIG. 8 shows interior of the housing 22 between front surface of housing 22 and rear surface of housing 22. Inlet nozzle 25 leads to channel 30 that splits into an irrigation fluid path and an accumulatable fluid path. The first part of the irrigation fluid path is from channel 30 to housing outlet 27 through a pressure-reducing labyrinth 33 in the interior of the housing 22 and through channel 32. The second part of the irrigation fluid path is from housing outlet 27 to emitter outlet 26 through the space formed in interior of cover 23. The accumulatable fluid path is from channel 30 to fluid-accumulation chamber 29 through pressure-reducing labyrinth 31, channel 34 and chamber orifice 28.

The inlet nozzle 25 is designed to be inserted into an irrigation pipe. When an irrigation cycle starts, the pressurized fluid entering inlet nozzle 25 from the irrigation pipe flows from channel 30 to housing outlet 27 through pressure-reducing labyrinth 33 and channel 32. The reduced pressure at housing outlet 27 results in a drip flow into the empty space surrounding fluid-accumulation chamber 29 and enclosed by the interior of cover 23 and from there drips to the outside environment through emitter outlet 26. Simultaneously to the drip flow from emitter outlet 26, the pressurized fluid in the irrigation pipe flows through the accumulatable fluid path from channel 30 to fluid-accumulation chamber 29 through pressure-reducing labyrinth 31, channel 34 and chamber orifice 28.

As time progresses during the irrigation cycle, the fluid-accumulation chamber 29 accumulates fluid and fills the space enclosed by the interior of cover 23. When the fluid-accumulation chamber 29 accumulates a fluid amount that expands the fluid-accumulation chamber 29 sufficiently to block the emitter outlet 26, it transitions from its first state of being free of accumulatable fluid and allowing drip flow from emitter outlet 26 to its second state of containing a predetermined amount of fluid and blocking drip flow from emitter outlet 26. The fluid-accumulation chamber 29 would remain in its second state thereby continuing to block flow from outlet 26 for as long as the irrigation pipe remains pressurized.

When the irrigation cycle is complete and fluid pressure at inlet nozzle 25 drops, the fluid-accumulation chamber 29 contracts and discharges its fluid content through chamber orifice 28 back into the irrigation pipe through channel 34, labyrinth 31, channel 30 and inlet nozzle 26. At the end of this discharging process, the fluid-accumulation chamber 29 reverts back to its first state of being free of accumulatable fluid.

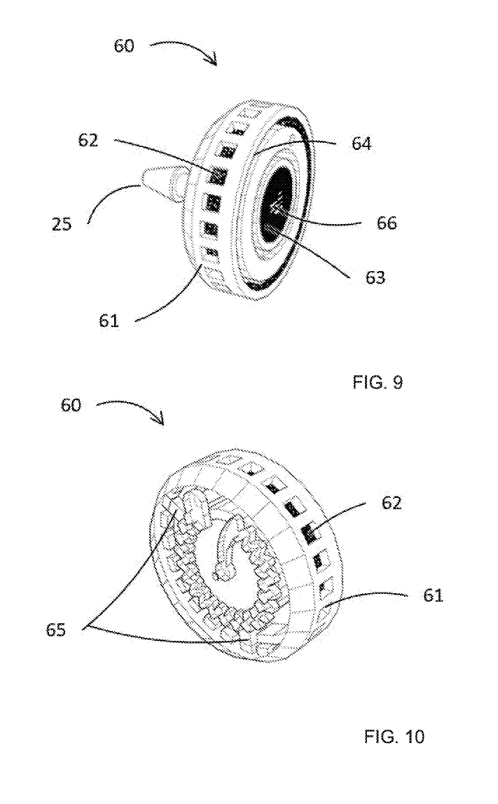

FIG. 9 shows yet another embodiment of the presently disclosed subject matter in the form of an on-line drip irrigation emitter having housing 60 with the fluid-accumulation chamber 63 in its first state of being free of accumulatable fluid. Housing 60 is designed so that its fluid-accumulation chamber 63 transitions to its second state only when a predetermined level of moisture has been reached at the exterior of the emitter outlet 26.

The housing 60 is a modification of the housing 22 of emitter 20 designed to facilitate a different accumulatable fluid path. The structure of cover 23 is the same as that of emitter 20, as is the irrigation fluid path from inlet nozzle 25 to emitter outlet 26.

FIG. 10 shows interior of housing 60 between front surface of housing 60 and rear surface of housing 60. The housing 60 further comprises openings 61 to the emitter' s exterior, a round channel 64 and orifices 65 connecting round channel 64 to fluid-accumulation chamber 63. The interior of the round channel 64, orifices 65 and fluid-accumulation chamber 63 house a moisture-absorbing material 62. The fluid-accumulation chamber 63 further houses a moisture-sensitive material 66 with the property of expanding when its moisture level increases and contracting when its moisture level decreases. The accumulatable fluid path of housing 60 is formed from the exterior of the emitter to the fluid-accumulation chamber 63 through openings 61, round channel 64 and orifices 65. The irrigation flow path and accumulated-fluid path are arranged to prevent fluid communication of the orifices 65 with the emitter inlet 25.

When the moisture level at the exterior of the emitter increases, the moisture-absorbing material 62 transfers moisture from the exterior to the moisture-sensitive material 66 via the accumulatable fluid path of housing 60. In response to the rising moisture level, the moisture-sensitive material 66 expands, thereby accumulating fluid in the fluid-accumulation chamber 63 to a point where it transients to its second state of blocking drip flow from outlet 26.

When the moisture level at the exterior of the emitter decreases, the moisture-absorbing material 62 transfers moisture from the moisture-sensitive material 66 via the accumulatable fluid path of housing 60 to the exterior of the emitter. In response to dropping moisture level, the moisture-sensitive material 66 contracts, thereby collapsing the fluid-accumulation chamber 63 to a point where it transients back to its first state of being free of accumulatable fluid and allowing drip flow from emitter outlet 26.

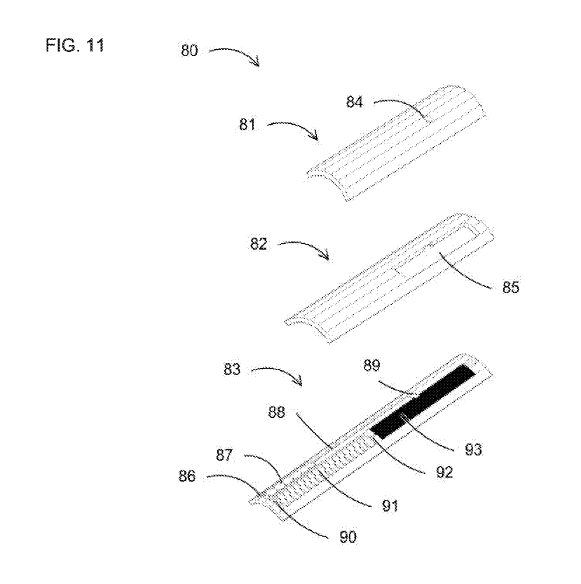

FIG. 11 illustrates a yet another embodiment of the presently disclosed subject matter in the form of an inline drip irrigation emitter 80 designed so that its fluid-accumulation chamber transitions to its second state only when a predetermined amount of irrigation fluid has been dispensed from its emitter outlet.

The drip irrigation emitter 80 is configured for being integrally attached to an interior surface of an irrigation pipe so as to provide fluid communication of the emitter inlets 86, 90 with an interior of the irrigation pipe and of the emitter outlet 84 with an exterior of the pipe.

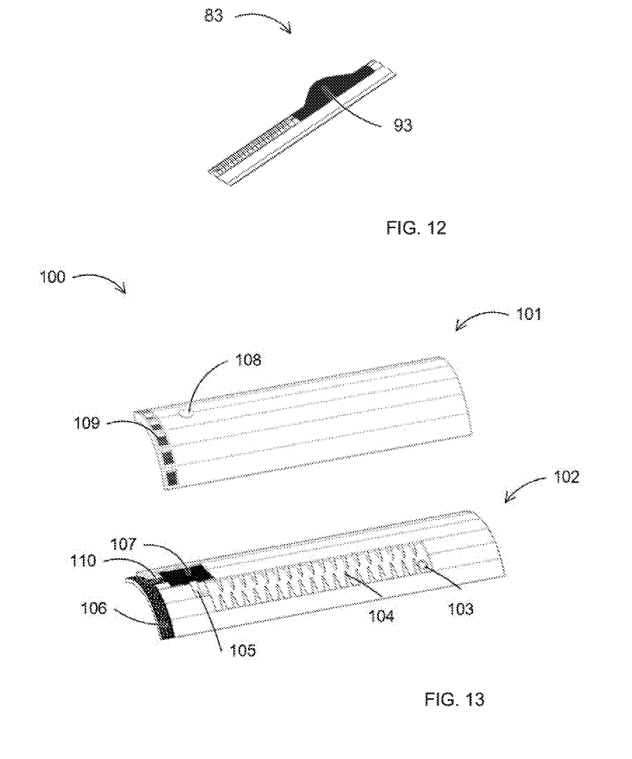

Drip irrigation emitter 80 comprises a housing implemented using a first layer 82 and a second layer 83. Emitter 80 further comprises a cover 81. The first layer 82 is attached on top of second layer 83 to form a housing with open space 85 over which the cover 81 is placed. The second layer 83 is presented with the fluid-accumulation chamber 93 in its first state of being free of accumulatable fluid. FIG. 12 shows the second-layer housing 83 with the fluid-accumulation chamber 93 in its second state of containing a predetermined amount of accumulatable fluid.

The functionality of drip irrigation emitter 80 is the same as that of the embodiment described using FIGS. 4-8 but its irrigation fluid path and accumulatable fluid path are constructed differently.

The first part of the irrigation flow path is formed from an inlet 86 to housing outlet 89 through pressure-reducing labyrinth 87 and channel 88. The second part of the irrigation flow path is formed from housing outlet 89 to emitter outlet 84 through open space 85. The accumulated-fluid path is formed from an inlet 90 to fluid-accumulation chamber 93 through pressure reducing labyrinth 91 and orifice 92. The irrigation flow path and accumulated-fluid path are arranged to prevent fluid communication of the orifice 92 with the emitter inlet 86.

FIG. 13 shows a yet another embodiment of the presently disclosed subject matter in the form of an integral drip irrigation emitter 100 with the fluid-accumulation chamber 107 in its first state of being free of accumulatable fluid. Emitter 100 is designed so that the fluid-accumulation chamber 107 transitions to its second state only when a predetermined level of moisture has been reached at the exterior of the emitter outlet 108.

The drip irrigation emitter 100 is configured for being integrally attached to an interior surface of an irrigation pipe so as to provide fluid communication of the emitter inlet 103 with an interior of the irrigation pipe and of the emitter outlet 108 with an exterior of the pipe.

The functionality of emitter 100 is the same as that of the yet another embodiment described using FIGS. 9-10 but its irrigation fluid path and accumulatable fluid path are constructed differently.

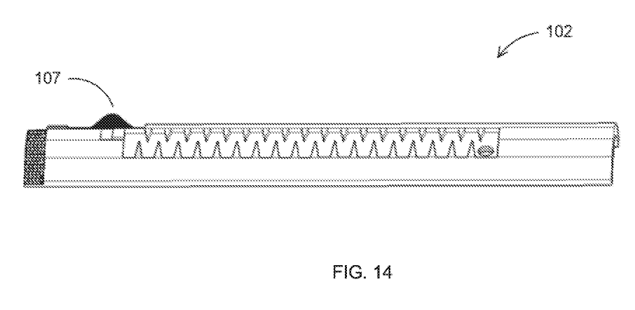

Drip irrigation emitter 100 comprises a housing 102 and a cover 101. The cover 101 is placed over the housing 102 to form an open space on top of the fluid-accumulation chamber 107. FIG. 14 shows the housing 102 with the fluid-accumulation chamber 107 in its second state of being full.

The first part of the irrigation flow path is formed from an inlet 103 to housing outlet 105 through pressure-reducing labyrinth 104. The second part of the irrigation flow path is formed from housing outlet 105 to emitter outlet 108 through the open space enclosed by cover 101 above fluid-accumulation chamber 107. The accumulatable fluid path of housing 102 is from the exterior of the emitter outlet 108 to the fluid-accumulation chamber 107 through openings 109, channel 106 and orifice 110. Openings 109, channel 106, orifice 110 and fluid-accumulation chamber 107 house a moisture-absorbing material. Fluid-accumulation chamber 107 further houses a moisture-sensitive material.

The embodiments described above were presented by way of non-limiting examples only, and the presently disclosed subject matter has features different from those described above.

For example, the amount of fluid in the fluid-accumulation chamber when in its first and second state can be other than zero and maximal possible, respectively. In other words, in the first state the chamber does not need to be completely empty of fluid but rather can have a minimal amount of fluid therein, and in the second state the amount of fluid does not need to be such as to completely block the emitter outlet. Accordingly, the emitter can be configured to provide the rate of drip flow through outlet 12 that will gradually decrease as the fluid-accumulation chamber transitions from its first state of being free of accumulatable fluid or having its minimal amount and allowing drip flow through outlet 12, to its second state of containing a predetermined amount of accumulatable fluid which is less than that needed for preventing drip flow through outlet 12.

It should also be clear that the irrigation cycle described with reference to FIG. 3 may follow a different regime of applying pressurized fluid to fluid lines 54. For example, it is possible to introduce into the pipe pressurized fluid of relatively low pressure for a relatively long period of time instead of a relatively high pressure for a relatively short period of time.

It should further be clear from the aforementioned operation of irrigation emitter 20 that the fluid-accumulating chamber 29 can be made in a variety of ways. For example, it can be made of an expandable fluid impermeable material such as an elastomer sealingly attached to the rear surface of the housing around its orifice.

It should further be clear from the aforementioned operation of irrigation emitter 20 that the restriction of drip flow from emitter outlet 26 following the second state of fluid-accumulation chamber 29 may be implemented in a variety of ways. For example, the fluid-accumulation chamber 29 can be configured to actuate a mediating mechanism such as a gate valve or ball valve. In another example, fluid-accumulation chamber 29 can push a flexible diaphragm membrane to block emitter outlet 26.

It should be further clear from the aforementioned operation of housing 60 that there is a variety of materials that can be used as the moisture-absorbing material 62. For example, the moisture-sensitive material 62 may be a fabric supporting capillary action made of cellulose fibers. There is also a variety of materials that can be used as the moisture-sensitive material 66. For example, the moisture-sensitive material 66 may be a super absorbent polymer based on potassium polyacrylate.

1-21. (canceled)

22. A drip irrigation emitter comprising:
an emitter inlet, an emitter outlet, an irrigation fluid path extending there between including a pressure-reducing mechanism configured to convert fluid flow entering the emitter inlet under pressure, into a drip flow from the outlet, and
a fluid-accumulation chamber having at least one chamber orifice configured for being brought into fluid communication with an exterior of the emitter for receiving therefrom an accumulatable fluid and further configured to allow introduction of the accumulatable fluid into the chamber via the orifice, to cause the chamber to change its state between a first state, in which the amount of said accumulatable fluid in the chamber is minimal and at least one second state, in which amount of the accumulatable fluid in the chamber reaches a predetermined value higher than the minimal value, the arrangement being such that when the chamber is in the second state, drip flow rate through the emitter outlet changes in accordance with said predetermined value.

23. The drip irrigation emitter according to claim 22, wherein in one of the second states fluid communication is prevented between the pressure-reducing mechanism and the emitter outlet.

24. The drip irrigation emitter according to claim 22, wherein in the first state of the chamber, it is free of said accumulatable fluid.

25. The drip irrigation emitter according to claim 22, wherein said chamber is configured for removal of the accumulatable fluid therefrom, optionally, via said orifice.

26. The drip irrigation emitter according to claim 22, wherein the pre-determined amount of the accumulatable fluid, which can be introduced in the chamber to bring it into said second state, is selected so as to ensure that this amount is reached only when a predetermined amount of irrigation fluid has been dispensed from the emitter outlet.

27. The drip irrigation emitter according claim 22, further comprising a housing having a housing front surface and a housing rear surface, the housing front surface being formed with said emitter inlet and the housing rear surface being formed with a housing outlet, the housing comprising a first part of said irrigation fluid path extending between said emitter inlet and the housing outlet, with said pressure-reducing mechanism therebetween.

28. The drip irrigation emitter according to claim 27, further comprising a cover formed with said emitter outlet, the cover being so assembled with the housing as to form a space between the housing outlet and the emitter outlet, said space constituting a second part of said irrigation fluid path.

29. The drip irrigation emitter according to claim 28, wherein said space is configured to accommodate said chamber at least when in its second state so as to prevent the fluid flow along the second part of the irrigation fluid path.

30. The drip irrigation emitter according to claim 27, wherein the orifice of said chamber is disposed in said rear surface of the housing at a location spaced from said housing outlet.

31. The drip irrigation emitter according to claim 22, wherein said orifice of the chamber is in fluid communication with the emitter inlet via an accumulatable fluid path, so as to allow fluid entering the emitter via said emitter inlet to simultaneously flow along the first part of the irrigation fluid path and along the accumulatable fluid path.

32. The drip irrigation emitter according to claim 31, wherein said accumulatable fluid path comprises an additional pressure-reducing mechanism.

33. The drip irrigation emitter according to claim 32, wherein said additional pressure-reducing mechanisms of the accumulatable fluid path and the pressure-reducing mechanism of the irrigation fluid path are not identical.

34. The drip irrigation emitter according to claim 22, configured for being mounted onto an exterior surface of an irrigation pipe so as to provide fluid communication of the emitter inlet with an interior of the irrigation pipe.

35. The drip irrigation emitter according to claim 22, configured to be integrally attached to an interior surface of an irrigation pipe so as to provide fluid communication of the emitter inlet with an interior of the irrigation pipe and of the emitter outlet with an exterior of the pipe.

36. An irrigation pipe comprising a plurality of drip irrigation emitters according to claim 22, disposed at different distances from a location, at which the pipe is configured to receive therein pressurized irrigation fluid.

37. The irrigation pipe according to claim 36, operable at least at one fluid pressure at said location so that, once said chamber is in its second state in at least one of the drip emitters, at least some of the remaining drip emitters will experience an increased pressure of fluid at their inlets.

38. An irrigation pipe comprising a plurality of drip irrigation emitters disposed at different distances from a location, at which the pipe is configured to receive therein pressurized irrigation fluid, each emitter comprising:
an emitter inlet, an emitter outlet, an irrigation fluid path extending therebetween including a pressure-reducing mechanism configured to convert fluid flow entering the emitter inlet under pressure, into a drip flow from the outlet, and
a mechanism configured to change a state of the fluid irrigation path between a first, operational state allowing said drip flow from the outlet, and a second state in which fluid communication is prevented between the pressure-reducing mechanism and the emitter outlet, so that at least at one fluid pressure at said location, at least once the state of the irrigation fluid path reaches its second state in at least one of the drip emitters, at least some of the remaining drip emitters will experience an increased pressure of fluid at their inlets.

39. A method of producing a drip irrigation emitter with a drip flow rate dependent on the amount of fluid that has been dispensed therefrom, the method comprising providing the emitter with a fluid-accumulation chamber having at least one chamber orifice configured for being brought into fluid communication with an exterior of the emitter for receiving therefrom an accumulatable fluid and further configured to allow introduction of the accumulatable fluid into the chamber via the orifice, to cause the chamber to change its state between a first state, in which the amount of said accumulatable fluid in the chamber is minimal and at least one second state other than the first state, in which amount of the accumulatable fluid in the chamber reaches a predetermined value higher than the minimal value, the arrangement being such that when the chamber is in the second state, drip flow rate through the emitter outlet changes in accordance with said predetermined value.

40. A method of drip irrigation by means of a pipe comprising a plurality of drip irrigation emitters according to claim 22 disposed at different distances from a location, at which the pipe is configured to receive therein pressurized irrigation fluid, said method comprising using as at least a part of said emitters drip irrigation with drip flow rate from their outlets which varies between a maximal rate in a first, operational state of the emitter and a reduced rate in at least one second state of the emitter, so that at least at one fluid pressure at said location, at least when at least one of the drip emitters is in its second state, at least some of the remaining drip emitters will experience an increased pressure of fluid at their inlets.

41. The drip irrigation emitter according to claim 26, further comprising a housing having a housing front surface and a housing rear surface, the housing front surface being formed with said emitter inlet and the housing rear surface being formed with a housing outlet, the housing comprising a first part of said irrigation fluid path extending between said emitter inlet and the housing outlet, with said pressure-reducing mechanism therebetween, and further comprising a cover formed with said emitter outlet, the cover being so assembled with the housing as to form a space between the housing outlet and the emitter outlet, said space constituting a second part of said irrigation fluid path.
